(19) United States
(12) Patent Application Publication
(10) Pub. No.: US 2008/0033142 A1
(43) Pub. Date: Feb. 7, 2008

(54) PACKAGE FOR INK JET RECORDING MATERIAL

(75) Inventors: Yasuhiro OGATA, Fujinomiya-shi (JP); Hirokazu SHIMADA, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/833,315

(22) Filed: Aug. 3, 2007

(30) Foreign Application Priority Data
Aug. 3, 2006 (JP) 2006-211636

(51) Int. Cl. C08G 63/00; C08G 64/00

(52) U.S. Cl. 528/271; 528/370

(57) ABSTRACT

A package for an ink jet recording material is provided, capable of mitigating the burden on the environment caused by discarding packaging materials, and capable of suppressing yellowing on the surface of an ink jet recording material contained therein, a printed portion of the ink jet recording material having favorable ozone resistance when printed by a dye ink printer, and capable of suppressing bronzing when printed on by a pigment ink printer.

The packaging material of the package for the ink jet recording material is formed of a packaging material including a polylactic acid resin and a polyalkylene carbonate, the ink jet recording material contained therein is formed of an ink jet recording material in which an ink receiving layer including fine inorganic particles and a thioetheric compound is disposed on a support, and a layer including a colloidal silica and a cationic compound is disposed at the ink receiving layer.

### CROSS-REFERENCE TO RELATED APPLICATION

This application claims priority under 35USC119 from Japanese Patent Application No. 2006-211636, the disclosure of which is incorporated by reference herein.

### BACKGROUND OF THE INVENTION

1. Field of the Invention

The present invention concerns a package for an ink jet recording material.

2. Description of the Related Art

As a recording material for ink jet recording systems, an ink jet recording material is used in which an ink receiving layer containing fine inorganic particles is disposed on a support. As a product, the ink jet recording material may be in the form of an elongated roll or in the form of multiple stacked sheet-like materials. Nevertheless, in any form, the ink jet recording materials are shipped as a package sealed in a film resin bag or a film resin box or container. As the packaging material for the packages, flexible resins being excellent in transparency and heat resistance are used. Specifically, such resins include soft polyvinyl chloride, soft polyvinylidene chloride, polypropylene, and polyethylene.

To reduce chemical and physical deterioration of the ink jet recording materials, a protective sheet is also sealed in the packages (refer, for example, to JP-A No. 2005-225505: Patent Document 1). Patent Document 1 describes that yellowing of the ink receiving layer can be suppressed by sealing a protective sheet having a specified Bekk smoothness at the outermost portion of the ink jet recording material.

In the packages described above, synthetic petrochemical resins are used as the film resin to reduce chemical deterioration of the packaged ink jet recording material. When using certain synthetic resins, the protective sheet as described above has been sealed in the package for suppressing deterioration of the ink jet recording material caused by additives contained in the synthetic resins.

As resins other than synthetic resins, biodegradable film resins have attracted attention in recent years for purposes of environmental protection (refer, for example, to JP-A No. 2002-114899: Patent Document 2). Patent Document 2 describes a resin composition comprising a polylactic acid resin and a specific polyalkylene carbonate excellent in biodegradability, flexibility, transparency, heat resistance, and gas barrier properties.

Further, as a box-like packaging material for the ink jet recording material, storage cases for an ink jet recording material are used which are suitable for display on store shelves, with less occurrence of deformation or warping, even when they are suspended or stacked (refer, for example, to JP-A No. 2004-115108: Patent Document 3).

The method described in Patent Document 1 prevents yellowing of the outermost ink receiving layer that contacts with the packaging material, but cannot prevent yellowing of the ink receiving layer of all of the ink jet recording material contained in the package for the ink jet recording material.

Further, while Patent Document 2 describes various applications for biodegradable resin compositions comprising a polylactic acid resin and a specific polyalkylene carbonate, it neither describes nor suggests that any particular effect can be obtained in addition to the effects inherent to the biodegradable resin composition (i.e. the biodegradability of the packaging material) when it is used as the packaging material for the ink jet recording material.

### SUMMARY OF THE INVENTION

The present invention has been made in view of the above circumstances and provides a package for ink jet recording material. A first aspect of the invention provides a package for an ink jet recording material wherein an ink jet recording material in which at least an ink receiving layer including fine inorganic particles and a thioetheric compound is disposed on a support is packaged by a packaging material comprising a polylactic acid resin. A second aspect of the present invention provides a package for an ink jet recording material wherein an ink jet recording material in which at least an ink receiving layer including fine inorganic particles and a thioetheric compound is disposed on a support is packaged by a packaging material comprising a polylactic acid resin and a polyalkylene carbonate.

### DETAILED DESCRIPTION OF THE INVENTION

The present invention intends to provide a package for an ink jet recording material capable of mitigating the burden on the environment when the packaging material of the package for the ink jet recording material is discarded after use in the packaging application, capable of suppressing the occurrence of yellowing in the ink receiving layer for the incorporated ink jet recording material, having favorable ozone resistance for the printed portion of the ink jet recording material when printed by a dye ink printer, and suppressing the occurrence of bronzing when printed by a pigment ink printer.

According to the package for the ink jet recording material of the invention, an ink jet recording material in which at least an ink receiving layer containing fine inorganic particles and a thioetheric compound is disposed on a support is packaged by a packaging material comprising a polylactic acid resin.

Further, according to a package for an ink jet recoding material of the invention, an ink jet recording material in which at least an ink receiving layer containing fine inorganic particles and a thioetheric compound is disposed on a support is packaged by a packaging material containing a polylactic acid resin and at least one a polyalkylene carbonate.

In the invention, since the packaging material comprises the polylactic acid resin as a biodegradable resin, burden on the environment caused by a discarded packaging material can be mitigated. In addition, by the combination of the packaging material formed of the polylactic acid resin and the ink jet recording material containing the fine inorganic particles and the thioetheric compound in the ink receiving layer, occurrence of yellowing in the ink receiving layer of the ink jet recording material can be suppressed more effectively, further, the ozone resistance in the printed portion can be improved more when printed by a dye ink printer and occurrence of bronzing when printed by a pigment ink printer can be suppressed.

Further, in the invention, since the packaging material contains the polylactic acid resin as the biodegradable resin and the polyalkylene carbonate, burden on the environment cause by discarded packaging materials can be mitigated. In addition, by the combination of the packaging material formed of the polylactic acid resin and the ink jet recording material containing the fine inorganic particles and the thioetheric compound in the ink receiving layer, occurrence of yellowing in the ink receiving layer of the ink jet recording material can be suppressed more effectively, further, the ozone resistance in the printed portion can be improved more when printed by a dye ink printer and occurrence of bronzing when printed by a pigment ink printer can be suppressed.

The package for the ink jet recording material of the invention may be in any form so long as the ink jet recording material is packaged by the packaging material described above. Such form includes, for example, a form in which the ink jet recording material is sealed in the packaging material fabricated into a bag shape, or sealed in the packaging material molded into a box-like shape.

Specifically, they include packaged forms as described, for example, in JP-A Nos. 2004-115108, 2005-225510, 2001-180757, and 2002-86862.

As the packaging method, it is preferred that the incorporated ink jet recording material is packaged so as to be tightly sealed. This can more effectively suppress the occurrence of yellowing on the surface of the ink jet recording material and also improve the ozone resistance in the printed portion further.

Further, a protective sheet may be sealed further together with the ink jet recording material. This can suppress the occurrence of mechanical or chemical troubles of the incorporated ink jet recording material more effectively. As the protective sheet, known sheets can be used suitably.

(Ink Jet Recording Material) According to the ink jet recording material of the invention, an ink receiving layer containing fine inorganic particles and a thioetheric compound is disposed on a support.

### (Support)

As the support in the invention, waterproof supports are preferred and they include, for example, plastic resin films such as of polyester resins, for example, polyethylene terephthalate, diacetate resin, triacetate resin, acrylic resin, polycarbonate resin, polyvinyl chloride, polyimide resin, cellophane, and celluloid, those formed by bonding paper and a resin film and polyolefin resin-coated paper formed by laminating a hydrophobic resin such as a polyolefin resin at least on one surface of paper. The thickness of the waterproof supports is, preferably, from 50 to 500 μm and, more preferably, from 80 to 400 μm.

The polyolefin resin-coated paper support usable preferably in the invention (hereinafter referred to as polyolefin resin-coated paper) is to be described in details. The water content in the polyolefin resin coated paper used in the invention is not particularly restricted, and, with a view point of curling property, it is preferably within a range from 3.0 to 9.0 mass % and, more preferably, within a range from 4.0 to 9.0 mass %. The water content of the polyolefin resin coated paper can be measured by an optional water content measuring method. For example, an infrared moisture tester, absolute drying weight method, dielectric constant method or curl fisher method can be used.

The substrate paper constituting the polyolefin resin-coated paper is not particularly restricted and generally used paper can be used. For example, smooth raw material paper used for photographic supports is preferred. As pulp for constituting the substrate paper, natural pulp, regenerated pulp, synthetic pulp, and the like can be used each alone or as a mixture of two or more of them in admixture. For the substrate paper, additives generally used for paper making such as sizing agents, paper strength agents, fillers, antistatics, fluorescence brighteners, dyes, etc. can be blended.

Further, surface sizing agents, paper strength agents, fluorescence brighteners, antistatics, dyes, anchoring agents, etc. may be coated on the surface.

Further, although there is no particular restriction on the thickness of the substrate paper, the basis weight thereof is preferably within a range from 30 to 350 g/m². Particularly, those having a good surface smoothness formed by, for example, compression by applying a pressure using calendaring during or after paper making process can be used preferably.

The polyolefin resin for coating the substrate paper includes homopolymers of olefins such as low density polyethylene, high density polyethylene, polypropylene, polybutene, and polypentene, copolymers comprising two or more olefins such as an ethylene-propylene copolymer, and mixtures thereof and those having various densities and melt indexes can be used each alone or as a mixture thereof.

Further, it is preferred to add, in the resin of the polyolefin resin coated paper, various kinds of additives, for example, white pigments such as titanium oxide, zinc oxide, talc, and calcium carbonate, aliphatic acid amide such as stearic amide and arachic acid amide, aliphatic acid metal salts such as zinc stearate, calcium stearate, aluminum stearate, and magnesium stearate, antioxidants such as Irganox 1010 and Irganox 1076, blue pigments and dyes such as cobalt blue, ultramarine blue, cecilian blue, and phthalocyanine blue, and magenta pigments and dyes such as cobalt violet, fast violet, and manganese purple, fluorescence brighteners, and UV-ray absorbents, in appropriate combination.

A main method of manufacturing the polyolefin resin coated paper includes a so-called extrusion coating method of casting a polyolefin resin in a molten state under heating onto a running substrate paper. The polyolefin resin coated paper is coated with the resin on at least one surface of the substrate paper. Further, before coating the resin on the substrate paper, an activating treatment such as a corona discharging treatment or a flame treatment is applied preferably to the substrate paper. The rear face is usually a lusterless surface, and an activating treatment such as a corona discharge treatment or flame treatment may also be applied to the rear face, or optionally to both of the surface and the rear face. Further, while there is no particular restriction on the thickness of the resin coated layer, a resin coating is generally applied on one surface or on both surface and rear face at a thickness of from 5 to 50 μm per one surface. In a case of coating the resin only on one surface, the thickness of the polyolefin resin coated layer is preferably about from 5 to 40 μm with a view point of the curling property of the obtained ink jet recording material.

While the surface of the polyolefin resin coated paper coated with the ink receiving layer in the invention (hereinafter referred to as the surface of the polyolefin resin-coated paper) may be left as it is in the state of the substrate paper, it is preferred that the polyolefin resin is melted under heating by an extruder, extruded into a film shape between the substrate paper and a cooling roll, press-bonded and cooled to form resin coating in view of the gloss and the smoothness. In this case, the cooling roll is used for forming the surface shape of the polyolefin resin coating layer and the surface of the resin coating layer can be formed into a mirror surface, or embossed to a finely roughened surface or patterned matte shape or the like.

The surface of the polyolefin resin coated paper on the side oppose to the surface coated with the ink receiving layer in the invention (hereinafter referred to as the rear face of the polyolefin resin coated paper) may be left as it is in the state of the substrate paper surface in a case of resin coating the surface but it is preferred that the polyolefin resin is melted under heating by an extruder, extruded into a film shape between the substrate paper and the cooling roll, press bonded and cooled to apply resin coating in view of the improvement for the curling property and the printed image. In this case, it is preferred to emboss the surface into a finely roughened surface or patterned surface (for example, matte shape or the like) depending on the surface shape of the cooling roll such that Ra according to JIS-B-0601 is from 0.3 to 5 μm in view of the transportability in the printer and the printed images.

As the method of providing the rear face or the surface of the substrate paper with the polyolefin resin coating layer includes, for example, a method of coating an electron beam curable resin and then irradiating an electron beam, or a method of coating and then drying a coating liquid of a polyolefin resin emulsion and applying a surface smoothing treatment in addition to coating of the heat melted resin by extrusion. A polyolefin resin coated paper applicable to the invention can be obtained in any of the methods by embossing with the heat roll having unevenness, etc.

The surface of the polyolefin resin coated paper in the invention may be provided with an undercoat layer. The undercoat layer is previously coated and dried on the surface of a waterproof support before application of the ink receiving layer. The undercoat layer mainly contains a water soluble polymer or polymer latex that can be formed into a film. The water soluble polymer is, preferably, gelatin, polyvinyl alcohol, polyvinyl pyrrolidone, water soluble cellulose and the like and, particularly preferably, gelatin. The deposition amount of the water soluble polymer is, preferably, from 10 to 500 mg/m² and, more preferably, from 20 to 300 mg/m². Further, the undercoat layer preferably contains a surfactant and a film hardener. Further, before coating the undercoat layer to the resin coated paper, a corona discharging treatment is applied preferably.

(Fine Inorganic Particles)

The kind of the fine inorganic particles used in the invention has no particular restriction and preferred fine inorganic particles include gas phase method silica, colloidal silica, alumina, and alumina hydrate. The fine inorganic particles may be used either alone or two or more of them may be used in combination. Further, in the invention, the ink receiving layer may be of a monolayer structure or a multilayer structure. The monolayer structure includes a form of containing one of gas phase method silica, colloidal silica, alumina, and alumina hydrate or a form of using plural kinds of them together. Any of the forms may be adopted. In a case where the ink receiving layer has a multilayer structure, it includes a form constituting a multilayer with only one of the gas phase method, silica, alumina and alumina hydrate, a form containing different kinds of them in separate layers, etc. Specifically, it includes a 2-layer structure of a gas phase method silica and/or colloidal silica containing layer and an alumina or alumina hydrate containing layer, or a form of containing gas phase silica and/or colloidal silica of different particle sizes in separate layers.

The gas phase method silica used preferably in the invention is also referred to as a dry process silica relative to a wet process silica and it is generally prepared by flame hydrolysis method. Specifically, while a method of preparation by combustion of silicon tetrachloride with hydrogen and oxygen is generally known, silanes such as methyl trichlorosilane or trichlorosilane may also be used, instead of silicon tetrachloride, alone or in admixture with silicon tetrachloride. The gas phase method silica is marketed and available as Aerosil from Nippon Aerosil Co. and as a QS type from Tokuyama Co.

The average primary grain size of the gas phase method silica is preferably within a range from 3 to 50 nm and it is preferred to use those having an average primary grain size within a range from 5 to 20 nm and a specific surface area according to EET method within a range from 90 to 500 m²/g. The BET method referred to herein is one of surface area measuring methods for powder by a gas phase adsorption method, which is a method of determining a total area of a 1 g of a specimen, that is, a specific surface area from an adsorption isothermal curve. Usually, a nitrogen gas is often used as an adsorption gas and a method of measuring the adsorption amount by the change of the pressure or volume of a gas to be adsorbed has been used most frequently. The formula of Brunauer, Emmett, and Teller is one of most famous equations for expressing the isothermal curve of multi-molecular adsorption, which is referred to as the BET formula and used generally for the determination of the surface area. The surface area is obtained by determining the adsorption amount based on the BET formula and multiplying the area where one adsorption molecule occupies the surface.

The alumina usable in the invention, γ-alumina which is Y-type crystals of aluminum oxide is preferred and, among all, δ group crystals are preferred. In γ-alumina, the primary particle can be made as small as about 10 nm, and those obtained by pulverizing several thousands to several ten thousands nm to about 50 to 300 nm by supersonic waves, a high pressure homogenizer, a counter collision type jet pulverizer or the like can be used preferably.

The alumina hydrate used in the invention is represented by the constitutional formula: Al₂O₃. nH₂O (n=1 to 3). A case where n is 1 represents an alumina hydrate of a boehmite structure and a case where n is greater than 1 and less than 3 represents an alumina hydrate of a pseudo boehmite structure. The alumina hydrate is obtained by known production processes such as hydrolysis of an aluminum alkoxide, for example, aluminum isopropoxide, neutralization of an aluminum salt with an alkali or hydrolysis of an aluminate salt.

The average grain size of the primary particles of the alumina hydrate is, preferably, from 5 to 50 nm and, for obtaining higher gloss, it is preferred to use particles of a plate shape with the grain size of from 5 to 20 nm and the average aspect ratio (ratio of average grain size to average thickness) of 2 or more.

The ink jet recording material in the invention has at least one ink receiving layer containing mainly fine inorganic particles. In this case, “containing mainly fine inorganic particles” means that the layer contains 50 mass % or more based on the entire solid contents constituting the ink receiving layer and means that it contains, preferably, 60 mass % and, particularly preferably, 65 mass % or more. In the invention, the total amount of the fine inorganic particles contained in the ink receiving layer (in a case where the ink receiving layer mainly containing fine inorganic particles is two or more layers, this means the total amount thereof) comprises preferably, within a range from 10 to 50 g/m² and, more preferably, within a range from 15 to 40 g/m².

(Thioether Type Compound)

In the ink jet recording material in the invention, an ink receiving layer containing at least one thioether type compound is provided. The thioether type compound preferably contains at least one compound represented by the following Formula (1).

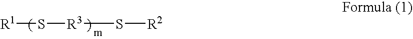

In Formula (1), R¹ and R² independently represent a hydrogen atom, alkyl group, or aromatic group; R¹ and R² may be identical or different to each other, or may be joined to form a ring. Further, at least one of R¹ and R² is preferably an alkyl group or aromatic group substituted with a hydrophilic group such as an amino group, ammonium group, hydroxyl group, sulfonic acid group, carboxyl group, aminocarbonyl group, or aminosulfonyl group. R³ represents an alkylene group which may be substituted or an oligo(alkyleneoxy)alkylene group which may be substituted. m represents an integer of from 0 to 10; and when m is 1 or more at least one sulfur atom bonded to R³ may be a sulfonyl group.

In the invention, it is more preferred that the thioether type compound represented by Formula (1) is at least one member selected from 3,6-dithio-1,8-octanediol, bis[2-(2-hydroxyethylthiol)ethyl]sulfone, 3,6,9-trithio-1,11-undecanediol, 4-(methylthio)phenol and 2-(phenylthio)ethanol.

(Other Additives)

The ink receiving layer of the ink jet recording material in the invention can further contain, in addition to the fine inorganic particles and the thioether type compound, those additives such as an organic binder, cationic compound, hydrophobic highly boiling organic material, and film hardener.

(Organic Binder)

The ink receiving layer preferably contains an organic binder for maintaining the property as a film. For the organic binder, various kinds of water soluble polymers or polymer latexes are used preferably. For the water soluble polymer, polyvinyl alcohol, polyethylene glycol, starch, dextrin, carboxymethyl cellulose, polyvinyl pyrrolidone, polyacrylate ester type polymers and derivatives thereof are used for instance and particularly preferred organic binders are completely or partially saponified polyvinyl alcohol or cationically modified polyvinyl alcohol.

Among the polyvinyl alcohols, particularly preferred are those partially or completely saponified products with a saponification degree of 80% or more. The average polymerization degree of the polyvinyl alcohol is preferably within a range from 500 to 5000. Further, the cationically modified polyvinyl alcohols are, for example, polyvinyl alcohols having primary to tertiary amino groups or quaternary ammonium groups in the main chains or on the side chains of polyvinyl alcohols as described in JP-A No. 61-10483.

The polymer latex usable for the organic binder includes, for example, acrylic latexes such as homopolymers or copolymers of acrylate esters or methacrylate esters of alkyl group, aryl group, aralkyl group, and hydroxyalkyl group, acrylonitrile, acrylamide, acrylic acid and methacrylic acid, or copolymers of the monomer as described above and styrene sulfonic acid, vinyl sulfonic acid, itaconic acid, maleic acid, fumalic acid, maleic acid anhydride, vinyl isocyanate, allylisocyanate, vinyl methyl ether, vinyl acetate, styrene, or divinylbenzene. For the olefinic latexes, polymers comprising copolymers of vinyl monomers and diolefins are preferred and, as the vinyl monomers, styrene, acrylonitrile, methacrylonitrile, methyl acrylate, methyl methacrylate, and vinyl acetate are used preferably and the diolefins include, for example, butadiene, isoprene, and chloroprene.

The organic binder is used preferably within a range from 5 to 35 mass % to the fine inorganic particles for the ink receiving layer in the invention and it is used particularly preferably within a range from 10 to 30 mass %.

(Cationic Compound)

In a case where the ink receiving layer in the invention contains the gas phase method silica as the fine inorganic particles, it preferably contains further a cationic compound together. By incorporation of the cationic compound to the ink receiving layer, cracks can be prevented and the water proofness can be improved in the ink receiving layer. Further, by providing a layer containing a colloidal silica and a cationic compound on the ink receiving layer containing the cationic compound, the scratch resistance, waterproofness and ink absorption are further improved and, in addition, agglomeration at the boundary between the two layers can be suppressed and, as a result, unevenness in the coating or gloss can be eliminated.

In a case where the alumina or alumina hydrate is contained as the fine inorganic particles of the ink receiving layer, sufficient resistance to cracks and water can be obtained by not always using the cationic compound in combination.

For the cationic compound, a cationic polymer or a water soluble polyvalent metallic compounds are used preferably. The cationic polymer and the water soluble polyvalent metallic compound can be used each alone or two or more of them can be used in combination.

The cationic polymer includes water soluble cationic polymers having a quaternary ammonium group, phosphonium group, and acid adducts of primary to tertiary amine. For example, they include specifically, polyethylene imine, polydialkyldiallylamine, polyallylamine, alkylamine epochlorhydrin polycondensation products, and cationic polymers described, for example, in JP-A Nos. Sho 59-20696, Sho 59-33176, Sho 59-33177, Sho 59-155088, Sho 60-11389, Sho 60-49990, Sho 60-83882, Sho 60-109894, Sho 62-198493, Sho 63-49478, Sho 63-115780, Sho 63-280681, Hei 1-40371, Hei 6-234268, Hei 7-125411, and Hei 10-193776. The mass average molecular weight of the cationic polymer used in the invention is, preferably, 100,000 or less and, more preferably, 50,000 or less, and the lower limit thereof is about 2,000.

The amount of use of the cationic polymers is preferably within a range from 1 to 10 mass % relative to the fine inorganic particles.

Examples of a water soluble polyvalent metallic compound used for the invention include water soluble salts of metals selected from calcium, barium, manganese, copper, cobalt, nickel, aluminum, iron, zinc, zirconium, titanium, chromium, magnesium, tungsten and molybdenum. Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, copper(II)ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc sulfate hexahydrate, zinc sulfate, zirconium acetate, zirconium nitrate, basic zirconium carbonate, zirconium hydroxide, zirconium ammonium carbonate, zirconium potassium carbonate, zirconium sulfate, zirconium fluoride, zirconium chloride, zirconium chloride octahydrate, zirconium oxychloride, zirconium hydroxychloride, titanium chloride, titanium sulfate, chromium acetate, chromium sulfate, magnesium sulfate, magnesium chloride hexahydrate, magnesium citrate nonahydrate, sodium phosphotungstate, sodium tungsten citrate, 12-tungstophosphoric acid n-hydrate, 12-tungstosilicic acid 26-hydrate, molybdenum chloride, 12-molybdophosphoric acid n-hydrate. In these water soluble polyvalent metallic compounds, water soluble salts of metals selected from aluminum, zirconium or titanium are preferable. In the invention, water solubility in a water soluble polyvalent metallic compound signifies dissolution of 1% by mass or more in water at room temperature and under atmosphere pressure.

As water soluble aluminum compounds other than the above described ones, basic polyaluminum hydroxide compounds are usable preferably. These compounds in which the primary component is represented by the following Formula 1, 2 or 3, and basic polymeric polynuclear condensation ions such as [Al₆(OH)₁₅]³⁺, [Al₈(OH)₂₀]⁴⁺, [Al₁₃(OH)₃₄]⁵⁺ and [Al₂₁(OH)₆₀]³⁺ are stably contained.

[Al₂(OH)ₙCl₆₋ₙ]ₘ Formula 2

[Al(OH)₃]ₙAlCl₃ Formula 3

Alₙ(OH)ₘCl(₃ₙ₋ₘ₎0<m<3n Formula 4

These compounds are put on the market under the trade name of polyaluminum chloride (PAC) as a water treatment agent manufactured by Taki Chemical Co. Ltd., the trade name of polyaluminum hydroxide(Paho) manufactured by Asada Chemical Industry Co., Ltd., and the trade name of puraCHEM manufactured by Rikengreen Co., Ltd., and for the same purpose from other manufacturers, the compounds of various grades are easily available.

In the invention, these commercial products can be used as they are. The basic polyaluminum hydroxide compounds are described also in JP-B Nos. Hei 3-24907, and Hei 3-42591.

In the invention, the content of the water soluble polyvalent metallic compound in the ink receiving layer is preferably, from 0.1 g/m² to 10 g/m² and, more preferably from 0.2 g/m² to 5 g/m².

(Oil Droplets)

In the invention, various kinds of oil droplets can be incorporated in the ink receiving layer for improving the fragility of the film. As such oil droplets, hydrophobic high boiling organic solvents having a water solubility at a room temperature of 0.01 mass % or less (for example, liquid paraffin, dioctylphthalate, tricresyl phosphate, and silicone oil), and polymer particles (for example, particles in which one or more of polymerizable monomers such as styrene, butyl acrylate, divinyl benzene, butyl methacrylate and hydroxyethyl methacrylate are polymerized) can be incorporated. Such oil droplets can be used within a range, preferably, from 10 to 50 mass % to the organic binder.

(Film Hardener)

In the invention, the ink receiving layer preferably contains a film hardener together with the organic binder. Specific examples of the film hardener include aldehyde compounds such as formaldehyde and glutal aldehyde, ketone compounds such as diacetyl and chloropentane dione, bis(2-chloroethyl urea)-2-hydroxy-4,6-dichloro-1,3,5 triazine, compounds having reactive halogen as described in U.S. Pat. No. 3,288,775, divinyl sulfone, compounds having reactive olefins as described in U.S. Pat. No. 3,635,718, N-methylol compounds described in U.S. Pat. No. 2,732,316, isocyanates described in U.S. Pat. No. 3,103,437, adiridine compounds as described in U.S. Pat. Nos. 3,017,280 and 2,983,611, carbodiimide compounds described in U.S. Pat. No. 3,100,704, epoxy compounds, halogen carboxyaldehydes such as mucochroic acid, dioxane derivatives such as dihydroxydioxane, and inorganic film hardeners such as chlomium alum, zirconium sulfate, boric acid and borates as described in U.S. Pat. No. 3,091,537, and they can be used each alone or two or more of them in combination. Among them, boric acid and borate are preferred. The addition amount of the film hardener is, preferably, from 0.1 to 40 mass % and, more preferably, from 0.5 to 30 mass % to the organic binder constituting the ink receiving layer.

In the ink receiving layer of the invention, various kinds of known additives can be added further, for example, a coloring dye, coloring pigment, fixing agent for the ink dye, UV-ray absorbent, antioxidant, pigment dispersing agent, defoamer, leveling agent, corrosion inhibitor, fluorescence brightener, viscosity stabilizer, and pH controller. Further, pH of the coating liquid of the ink receiving layer of the invention is, preferably, within a range from 3.3 to 6.0 and, particularly, preferably, in a range from 3.5 to 5.5.

[Colloidal Silica Layer]

In the ink jet recording material of the invention, it is preferred to provide a layer containing a colloidal silica and a cationic compound (hereinafter referred to as a colloidal silica layer) further on the ink receiving layer. The colloidal silica layer is preferably a layer at the uppermost surface (uppermost layer). By the provision of the colloidal silica layer, occurrence of yellowing and occurrence of bronzing in the ink receiving layer can be suppressed more effectively.

The colloidal silica used in the invention is a colloidal dispersion into water of silicon dioxide obtained by heat aging a silica sol obtained by way of double composite decomposition of sodium silicate with an acid or the like or passing it through an ion exchange resin layer and this is a wet process synthesis silica with an average primary grain size of about several nm to 100 nm. As the colloidal silica, Snowtex ST-20, ST-30, ST-40, ST-C, ST-N, ST-20L, ST-O, ST-OL, ST-S, ST-XS, ST-XL, ST-YL, ST-ZL, ST-OZL, ST-AK, etc. are marketed from Nissan Chemical Industry Co.

For the colloidal silica used in the invention, those having an average primary grain size within a range from 30 nm to 100 nm are preferred with a view point of ink absorption and gloss. Further, two or more kinds of them of different average primary grain sizes are used preferably in combination. In this case, it is more preferred to use a colloidal silica with an average primary grain size of 30 nm or more and less than 60 nm, and a colloidal silica with an average primary grain size of 60 nm or more and 100 nm or less in combination, and the ratio of the colloidal silica with an average primary grain size of 30 nm or more and less than 60 nm to the total amount of the colloidal silica is preferably 60 mass % or more.

The particle shape of the colloidal silica includes spherical, chain (beads-like) shape or the like and a spherical colloidal silica is preferred with a view point of the effect of the invention, particularly, the scratch resistance and glossiness. Further, while the colloidal silica is anionic, nonionic, or cationic, anionic colloidal silica is preferred with a view point of the stability of the coating liquid of the colloidal silica, particularly, the stability of the coating liquid containing polyvinyl alcohol as the organic binder (agglomeration or separation of colloidal silica due to aging of the coating liquid).

The coating amount of the solid content of the colloidal silica in the colloidal silica layer is, preferably, from 0.1 to 8.0 g/m² and, more preferably, within a range from 0.3 to 5.0 g/m². This can further improve the glossiness and the scratch resistance without lowering the ink absorption.

In the invention, the colloidal silica layer contains a cationic compound. As the cationic compound, a cationic polymer or a water soluble polyvalent metallic compound can be used preferably. Details for the cationic polymer and the water soluble polyvalent metallic compound are identical with those described for the ink receiving layer described above. In the invention, the cationic polymer is preferred as the cationic compound used for the colloidal silica layer.

The addition amount of the cationic compound is, preferably, from 0.1 to 10 mass % and, more preferably, within a rang from 0.5 to 8.0 mass % based on the colloidal silica.

The colloidal silica further contains preferably an organic binder. The organic binder is used preferably by 10 mass % or less based on the colloidal silica and the lower limit is 0.5 mass %. The organic binder is used more preferably within a range from 1 to 7 mass %. By the incorporation of the organic binder in this range, the scratch resistance can be improved further without lowering the ink absorption.

The organic binder includes those inorganic binders described above used for the ink receiving layer. Among them, particularly preferred organic binders are completely or partially saponified polyvinyl alcohols or cationically modified polyvinyl alcohols. Among the polyvinyl alcohols, particularly preferred are those saponified partially with a saponification degree of 80% or more or those saponified completely. A polyvinyl alcohol with an average degree of polymerization of from 500 to 5,000 is preferred.

The cationically modified polyvinyl alcohol includes, for example, those polyvinyl alcohols having primary to tertiary amino groups or quaternary ammonium groups in the main chain or on the side chains of the polyvinyl alcohol described, for example, in JP-A No. Sho 61-10483.

In the colloidal silica layer, a film hardener can be used further in addition to the organic binder. The film hardener includes those film hardeners used in the ink receiving layer described above. Among the film hardeners, boric acid or borate salt is used particularly preferably. The colloidal silica layer can also contain, further surfactants, coloring dyes, coloring pigments, UV-absorbents, antioxidants, pigment dispersing agents, defoamers, leveling agents, corrosion inhibitors, fluorescence brighteners, viscosity stabilizers and pH controllers.

The ink jet recording material in the invention is preferably those produced by coating a coating liquid for at least one ink receiving layer containing fine inorganic particles and the thioether type compound, and the layer containing the colloidal silica and the cationic compound (colloidal silica layer) in this order on the support.

pH of the coating liquid for the colloidal silica layer is preferably within a range from 3.3 to 6.0. More preferably, pH of the coating liquid of the colloidal silica layer is within a range from 3.5 to 5.5.

The scratch resistance and the glossiness are improved by laminating the coating liquid for colloidal silica layer containing the cationic compound and having pH within the range described above on the ink receiving layer. Particularly, the ink absorption is improved remarkably and, in addition, agglomeration at the boundary between the ink receiving layer and the colloidal silica layer can be suppressed to eliminate the coating unevenness or gloss unevenness.

For the method of coating the ink receiving layer and the colloidal silica layer, while the effect of the invention can be obtained by any of the sequential application method of coating each by one layer (for example, by a blade coater, air knife coater, roll coater, bar coater, gravure coater, and reverse coater), or the simultaneous dual layer application method (for example, by a slide bead coater or slide curtain coater) in the invention, the simultaneous dual layer application method is used preferably.

The ink receiving layer and the colloidal silica layer have generally been coated sequentially so far (method of coating and drying a colloidal silica layer after coating and drying the ink receiving layer). However, in a case where the coating amount of the colloidal silica in the colloidal silica layer is 8 g/m² or less, further, 5 g/m² or less by solid content by sequential application, it has been found that the effect of glossiness and scratch resistance in the colloidal silica layer cannot sometimes be developed sufficiently. This is considered that in a case of providing a relatively thin colloidal silica layer on the ink receiving layer containing the coating and dried fine inorganic particles, the coating liquid for the colloidal silica layer partially permeates to the gaps in the ink receiving layer and no uniform colloidal silica layer can be obtained. Further, when air present in the gap of ink receiving layer diffuses in the coating liquid for the colloidal silica in the upper layer to form bubbles and generates crater-like coating defects (crater-like eye holes), this possibly hinders uniform coating of the colloidal silica layer.

Further, in a case of using a gas phase method silica, alumina or alumina hydrate with an average primary grain size of 50 nm or less, particularly, the gas method silica, as the fine inorganic particles of the ink receiving layer, when the colloidal silica layer is coated after once coating and drying the ink receiving layer containing the fine inorganic particles, fine cracks are sometimes caused in the ink receiving layer in a process in which the ink receiving layer is again moistened state and then dried.

The problem in a case of coating a relatively thin colloidal silica layer successively after coating and drying the ink receiving layer as described above can be overcome by the simultaneous dual layer application of the ink receiving layer and the colloidal silica layer. In this invention, the thin film layer application of the colloidal silica layer is preferred in view of the ink absorption. Since the colloidal silica is inferior in the ink absorption compared with other fine inorganic particles, for example, the gas phase method silica, alumina or alumina hydrate used preferably in the ink receiving layer of the invention, the colloidal silica layer is preferably a thin layer when it is provided to the upper layer. On the other hand, the colloidal silica is excellent in the glossiness and the scratch resistance and can obtain sufficient effect of high glossiness and scratch resistance even if it is a thin film in a case where a uniform coating surface can be formed. Accordingly, for satisfying high levels for the ink absorption, gloss and scratch resistance simultaneously, it can be considered extremely preferred for simultaneous double layer application of the thin colloidal silica layer and ink receiving layer containing fine inorganic particles.

In the simultaneous double layer application, plural coating liquids for the ink receiving layer and the colloidal silica layer can be coated in a lamination state to a support by using a coater such as a slide bead coater or a slide curtain coater. This may possibly result in an additional problem that agglomeration tends to occur at the boundary between the two layers in a state where the coating liquids for the ink receiving layer and the colloidal silica layer are laminated but this problem can be solved by incorporating a cationic compound to the coating liquid for the colloidal silica layer and controlling the pH of the coating liquid to a range from 3.3 to 6.0, preferably, to a range from 3.5 to 5.5.

While a preferred constitution of the colloidal silica layer is as has been described above, the concentration of the colloidal silica in the coating liquid of the layer is appropriately about from 3 to 25 mass % and, more preferably, from 5 to 15 mass %. A wet coating amount of the coating liquid for the colloidal silica layer is, preferably, about from 10 to 50 g/m² and, more preferably, from 10 to 30 g/m².

Also the constitution of the ink receiving layer is as has been described above, and the concentration of the fine inorganic particles in the liquid of the ink receiving layer is preferably about from 5 to 20 mass %. Also in a case where the ink receiving layer comprises plural layers, it is preferred that the concentration of the fine inorganic particles is within the range as described above for any of the layers. The wet coating amount of the coating liquid for the ink receiving layer is appropriately about from 100 to 300 g/m² in total, both for the case of a single layer or for the case of plural layers. The pH for the coating liquid of the ink layer is preferably within a range from 3.3 to 6 and, particularly preferably, within a range from 3.5 to 5.5. By controlling the pH to the range described above, ink absorption is improved and agglomeration at the boundary with the colloidal silica layer as the upper layer is further suppressed. It is preferred to further provide the colloidal silica layer.

(Packaging Material)

The package for the ink jet recording material of the invention is formed by packaging the ink jet recording material with the packaging material comprising a polylactic acid resin. When the packaging material comprises a biodegradable polylactic acid resin, burden on the environment due to the discarded packaging material can be mitigated.

(Polylactic Acid Resin)

The polylactic acid resin of the invention may be of optional structures so long as this is a polylactic acid resin having biodegradability and any of them can be used suitably. “Having biodegradability” means that biodegradation is recognized, for example, in ISO 14855 (JIS K 6953) “determination of the ultimate aerobic biodegradability and disintegration of plastic materials under controlled compositing conditions” and those decomposed by 60% or more within one-half year in “determination” described above.

Specific examples of the biodegradable polylactic acid resins in the invention include polymer blends or polymer alloys such as mixtures of polylactic acid, copolylactic acid, for example, lactic acid-hydroxycarboxylic acid copolymers, lactic acid-aliphatic polyhydric alcohol-polybasic acid copolymers, and polylactic acid, lactic acid-hydroxycarboxylic acid copolymers, and lactic acid-aliphatic polyhydric alcohol-aliphatic polybasic acid copolymers.

As the starting material for the polylactic acid resin, lactic acids and hydroxycarboxylic acids, aliphatic polyhydric alcohols, aliphatic polybasic acids and the like are used. Specific examples of the lactic acids include, for example, L-lactic acid, D-lactic acid, DL-lactic acid or mixtures thereof, or lactide as the cyclic dimmer of the lactic acid.

Further, specific examples of the hydroxycarboxylic acids that can be used together with the lactic acids include glycolic acid, 3-hydroxybutylic acid, 4-hydroxybutylic acid, 4-hydroxyvaleric acid, 5-hydroxyvaleric acid, and 6-hydroxycapronic acid and, includes further, cyclic ester intermediate products of hydroxycarboxylic acid, for example, glycolide as the dimmer of glycolic acid, and ε-caprolactone as the cyclic ester of 6-hydroxycaproic acid.

Further, specific examples of the aliphatic polyhydric alcohol that can be used together with lactic acids includes, for example, ethylene glycol, diethylene glycol, triethylene glycol, polyethylene glycol, propylene glycol, dipropylene glycol, 1,3-butanediol, 1,4-butanediol, 3-methyl-1,5-pentanediol, 1,6-hexanediol, 1,9-nonanediol, neopentylglycol, polytetramethylene glycol, 1,4-cyclohexanedimethanol, and 1,4-benzenedimethanol.

Further, specific examples of the aliphatic polybasic acid that can be used together with lactic acids include, for example, succinic acid, oxalic acid, malonic acid, glutaric acid, adipic acid, pimelic acid, suberic acid, azelaic acid, sebacic acid, undecanoic diacid, dodecanoic diacid, phenylsuccinic acid, and 1,4-phenylene diacetic acid. They can be used each alone or two or more of them can be used in combination.

Embodiments of the polylactic acid resins usable in the invention include those such as the followings (1) to (4):

(1) a lactic acid homopolymer,

(2) a copolylactic acid formed of 50 mass % or more of a lactic acid and 50 mass % or less of a hydroxycarboxylic acid other than the lactic acid,

(3) a copolylactic acid formed of 50 mass % or more of a lactic acid and 50 mass % or less of an aliphatic polyhydric alcohol and an aliphatic polybasic acid, and

(4) a copolylactic acid formed of 50 mass % or more of lactic acid, and 50 mass % or less of a hydroxycarboxylic acid other than the lactic acid and an aliphatic polyhydric alcohol and an aliphatic polybasic acid.

The copolylactic acid may be a random copolymer, a block copolymer or a mixture of them. The embodiment of the copolylactic acid used preferably in the invention includes, for example, those as shown below:

(1) a lactic acid block copolymer formed of 50 mass % or more of lactic acid and 50 mass % or less of caproic acid,

(2) a lactic acid block copolymer formed of 50 mass % or more of lactic acid and 50 mass % or less of 1,4-butanediol and succinic acid,

(3) a block copolymer comprising 50 mass % or more of polylactic acid segments and 50 mass % or less of polycaproic acid segments,

(4) a block copolymer comprising 50 mass % or more of polylactic acid segments and 50 mass % or less of polybutylene succinate segments.

In the invention, for the polylactic acid resin, a lactic acid homopolymer, a block copolymer having polylactic acid segments and polybutylene succinate segments and/or polycaproic acid segment can be used particularly preferably. The mass average molecular weight (Mw) and the molecular weight distribution of the polylactic acid resin used preferably in the invention are not particularly restricted so long as molding is possible substantially.

The molecular weight of the polylactic acid resin used in the invention is not particularly restricted so long as the resin shows substantially sufficient mechanical property and it is generally preferably from 10,000 to 500,000, more preferably, from 30,000 to 400,000 and, further preferably, from 50,000 to 300,000 as the mass average molecular weight (Mw). Generally, in a case where the mass average molecular weight (Mw) is less than 10,000, the mechanical property is not sometimes sufficient and, on the other hand, in a case where the molecular weight exceeds 500,000, the resin sometimes becomes difficult in handling and may result in economical disadvantage.

The polylactic acids in the embodiments described above may be used alone or may be used optionally as a combination of two or more of them. In the invention, the process for producing the polylactic acid resin (A) having biodegradability is not particularly restricted and can include specifically, for example, the following processes.

(1) A process of conducting direct dehydrative polycondensation reaction using lactic acid or a mixture of lactic acids and hydroxycarboxylic acids as the starting material (production process disclosed, for example, in JP-A No. 6-65360).

(2) In direct polymerization method of melt-polymerizing cyclic dimmers of lactic acid (lactide) (production process disclosed for example, in U.S. Pat. No. 2,758,987).

(3) Ring-opening polymerization method of melt-polymerizing, under the presence of a catalyst, a cyclic dimer of the lactic acids or hydroxycarboxylic acids, for example, lactide or glycoride, or a cyclic ester intermediate product such as ε-caprolactone (U.S. Pat. No. 4,057,537).

For producing the polylactic acid resin, aliphatic polyhydric alcohol such as glycerin and trimethylol propane, aliphatic polybasic acid such as butane carboxylic acid, or polyhydric alcohol such as polysaccharide may also be partially copolymerized, or the molecular weight may be increased by using a coupling agent (polymer chain extender) such as a diisocyanate.

In a case of producing the polylactic acid resin by direct dehydrative polycondensation of starting materials, a polylactic acid resin of high molecular weight having a strength suitable to the invention can be obtained by azeotropic dehydrative condensation of lactic acids or lactic acids and hydroxycarboxylic acids as the starting material preferably in the presence of an organic solvent, particularly, a phenyl ether type solvent and polymerizing them, particularly preferably, by a method of removing water from the solvent distilled by azeotropy to return the solvent rendered substantially anhydrous to the reaction system.

In the invention, the content of the lactic acid ingredient in the monomer system upon polymerization of the polylactic acid is 50 mass % or more, preferably, 60 mass % or more, more preferably, 70 mass % or more and, further preferably, 80 mass % or more.

The packaging material comprising the polylactic acid resin in the invention can be manufactured by subjecting the polylactic acid resin to molding fabrication such as extrusion molding, injection molding, calendar molding, blow molding, or balloon molding. Further, for the packaging material comprising the polylactic acid resin in the invention, various kinds of stabilizers, UV-ray absorbents, flame retardants, internal releasing agents, lubricants, plasticizers, organic fillers, inorganic fillers, pigments, pigment dispersing agents, etc. can be added within such a range as not deteriorating the effect of the invention.

The packaging material in the package for the ink jet recording material of the invention has a feature in that the material contains at least one polylactic acid resin and at least one polyalkylene carbonate. When the packaging material comprises the polylactic acid resin and a specified polyalkylene carbonate, the polylactic acid resin is excellent in the flexibility, transparency, heat resistance, and gas barrier property in addition to the excellent biodegradability inherent to the resin. Further, by combining the packaging material having the properties described above with the ink jet recording material, occurrence of yellowing in the ink receiving layer can be suppressed more effectively making it possible to further improve the ozone resistance and more effective suppression of bronzing in the printed portion.

The polylactic acid resin in the invention is as has been described above.

(Polyalkylene Carbonate)

Further, the polyalkylene carbonate in the invention is preferably a compound represented by the following Formula (5).

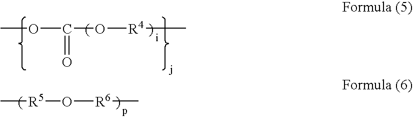

In Formula (5), R⁴ is at least one group selected from an ethylene group, propylene group, and a group represented by Formula (6), i represents an integer of from 1 to 15, preferably, from 1 to 10, and j represents an integer of from 3 to 15,000 and, preferably, from 10 to 10,000.

In Formula (6), R⁵ and R⁶ independently represent an alkylene group of from 2 to 6 carbon atoms, and p represents an integer of from 1 to 15. As the group represented by Formula (6), those groups in which p is an integer of 1 or 2 are preferred and, specifically, 3-oxapentanylene, 3-oxahexanylene, 3-oxaheptanylene, 3-oxa-1-methylpentanylene, 3-oxa-1-methylhexanylene group, etc., at p=1 are preferred.

The polyalkylene carbonate in the invention may also contain other alkylene groups as the alkylene group represented by R⁴ in Formula (5), in addition to ethylene group, propylene group, and the group represented by Formula (6), within a range not deteriorating the characteristic of the present invention, preferably, within a range of 20 mol % or less for the alkylene group represented by R⁴. Other alkylene groups include saturated aliphatic groups such as methylene, trimethylene, tetramethylene, pentamethylene, hexamethylene, heptamethylene, octamethylene, nonamethylene, decamethylene, dodecamethylene, ethylethylene, 1,2-dimethylethylene, 1,1-dimethylethylene, propylethylene, 1-ethyl-2-methylethylene, butylethylene, pentylethylene, hexylethylene, and octylethylene; cycloaliphatic groups such as 1,2-cyclopenthylene, 1,3-cyclopenthylene, 1,2-cyclohexylene, 1,3-cyclohexylene, 1,4-cyclohexylene, 1,3-cyclohexanedimethylene, 1,4-cyclohexanedimethylene, and cyclohexylethylene, and unsaturated aliphatic groups such as vinylethylene, allylethylene, and isopropenylethylene. Further, aromatic or heteroelement-containing groups such as styrene, benzylethylene, m-phenylene, p-phenylene, 4,4′-diphenylene, 4,4′-bisphenylene-2,2-propane, 4,4′-bisphenylenesulfone, and trifluoromethylethylene may also be contained.

For the polyalkylene carbonate used in the invention, it is particularly preferred that 80 mol % or more of the alkylene groups represented by R⁴ in Formula (5) are constituted with ethylene groups and, it is particularly preferred that 90 mol % or more is constituted with ethylene groups. Among them, polyethylene carbonate is particularly preferred. Further, it is preferred that 80 mol % or more of the alkylene groups represented by R⁴ in Formula (5) is constituted with ethylene groups and propylene groups and it is more preferred that 90 mol % is constituted with the ethylene groups and the propylene groups.

Alternatively, it is preferred that 80 mol % or more of the alkylene groups represented by R⁴ in Formula (5) is constituted with ethylene groups and trimethylene groups and it is more preferred that 90 mol % or more is constituted with ethylene groups and trimethylene groups. The molecular weight of the polyalkylene carbonate used in the invention is not particularly restricted and, generally, it is preferably from 500 to 1,000,000, more preferably, from 2,000 to 500,000, and particularly preferably, from 5,000 to 300,000 as the mass average molecular weight. The molecular weight can be determined by a known method such as GPC.

The polyalkylene carbonate used in the invention has the glass transition temperature, preferably of 40° C. or lower. This is preferred since the packaging material in the invention can be provided with flexibility and impact resistance due to low glass transition temperature. The glass transition temperature in the invention means a temperature measured by usual DSC (differential scanning calorimeter) at a temperature elevation rate of 10° C./min.

The polyalkylene carbonate used in the invention may be produced by any method with no particular restriction, and typical production process includes, for example, (1) a process by ester exchange between a carbonate ester such as dimethyl carbonate and glycol, (2) a process of reacting glycol and phosgene, (3) a process of ring-opening a cyclic carbonate, and (4) a process of copolymerizing an epoxide and gaseous carbon oxide in the presence of a zinc-containing solid catalyst ingredient (JP Nos. 2571269 and 2693584, which may be properly selected depending on a desired molecular structure or the like for production.

The packaging material containing the polylactic acid resin and the polyalkylene carbonate in the invention preferably comprises a resin composition containing (A) 30 to 95 mass parts of a biodegradable polylactic acid resin and (B) 70 to 5 mass parts of a polyalkylene carbonate represented by Formula (5) (assuming the total for (A) and (B) as 100 mass parts). The packaging material can be manufactured by subjecting the resin composition to molding fabrication such as extrusion molding, injection molding, calendar molding, blow molding, and balloon molding.

(Resin Composition)

Particularly, the resin composition in the invention contains the polylactic acid resin (A) preferably by 40 to 90 mass parts and, more preferably, by 45 to 80 mass parts and, particularly preferably, by 50 to 70 mass parts. Further, the resin composition contains the polyalkylene carbonate (B), preferably, by 60 to 10 mass parts, more preferably, by 55 to 20 mass parts and, particularly preferably, by 50 to 30 mass parts.

It is preferred that the content of (A) polylactic acid resin and (B) polyalkylene carbonate is within the range as described above since the flexibility is provided and, further, the gas barrier property is also improved without deteriorating the transparency and the heat resistance as the feature of polylactic acid. The resin composition in the invention may also contain a small amount of a resin other than the ingredient (A) and the ingredient (B) described above within such a range as not deteriorating the effect described above. Further, various kinds of stabilizers, UV-ray absorbents, flame retardants, internal releasing agents, lubricants, plasticizers, organic fillers, inorganic fillers, pigments, pigment dispersing agents may also be contained depending on the purpose.

In a case where the resin composition in the invention is in a film-shape, the haze value of the film is 40% or less, preferably, 30% or less, further preferably, 20% or less and, particularly preferably, 10% or less. The haze value was measured by using a film obtained by drying the resin composition thoroughly, putting a predetermined amount of the composition between two sheets of brass plates, aluminum plates and releasing films, melting the same at 200° C. and compressing the melts at 10 MPa for 1 min and then compressed and cooling them again at 10 MPa by a compression molder set to a temperature of 0° C. and into a 100 μm thickness by molding.

Further, the gaseous carbon dioxide permeation coefficient at 25° C. of the film is within a range of, preferably, 85 mL·mm/m²·day·atm or less, more preferably, 80 mL·mm/m²·day·atm or less, and particularly preferably, 75 mL·mm/m²·day·atm or less. Further, the Young's Modulus at 23° C. of the sheet comprising the resin composition is, preferably, 2,500 MPa or less, more preferably, from 2,200 to 50 MPa and, particularly preferably, from 2,000 to 100 MPa.

Further, the Young's modulus was measured by using a film obtained by drying the resin composition thoroughly, putting a predetermined amount of the composition between two sheets of brass plates, aluminum plates and releasing films, melting the same at 200° C. and compressing the melts at 10 MPa for 1 min and then compressing and cooling them at 10 MPa by a compression molder set to a temperature of 0° C. into a 500 μm thickness by molding. For the resin composition in the invention, the manufacturing method is not particularly restricted, and known usual manufacturing methods in a case of manufacturing resin compositions comprising thermoplastic resins can be properly adopted.

Specifically, a method of uniformly mixing the polylactic acid resin (A) such as the polylactic acid resin described above and the polyalkylene carbonate (B) described above by using a high speed stirrer or a low speed stirrer and then melt kneading the mixture by a single-screw or multiple-screw extruder having a sufficient kneading performance is adopted. Further, a method, for example, of mixing each of starting materials in a solid state by a Henschel mixer, ribbon blender or the like, or kneading the polymer while melting by using an extruder or the like may also be used. Further, a method of heat melting in a reactor having a depressurization device and a stirring device and then kneading the melt under a normal pressure or a reduced pressure can also be used. Among them, in the invention, a resin composition prepared by a method of melt-mixing starting materials mixed in a solid state by a double-screw extruder within a temperature range of from 180 to 220° C. is particularly preferred.

The resin composition manufactured by the method described above may be in any shape such as a pellet, rod, or powder and it is preferably taken out in the pellet shape. Further, the obtained resin composition can be put to solid phase polymerization. In the solid phase polymerization, low molecular weight volatile materials in the resin composition can be removed to improve the molecular weight. The method of the solid phase polymerization can be conducted by keeping to crystallize pellets of a resin sufficiently dried previously in an inert gas stream such as a nitrogen gas within a temperature range from 60 to 120° C. for 10 to 180 min, and then keeping the same within a temperature range from 90 to 150° C. for 0.5 to 200 hr in an inert gas stream such as a nitrogen gas, or under a reduced pressure.

In the resin composition of the invention, various kinds of stabilizers, UV-ray absorbents, flame retardants, internal releasing agents, lubricants, plasticizers, organic fillers, inorganic fillers, pigments, pigment dispersing agents, etc. within such a range as not deteriorating the effect of the invention can be added. By adding them appropriately, molding products and fabrication products such as films, sheet, filaments, yarns, textiles having desired physical properties can be manufactured.

Further, when the molding products or fabrication products such as films, sheets, filaments, yarns, and textiles obtained from the resin composition in the invention are put to heat treatment and/or stretching, fabrication products of high performance having high transparency, flexibility, and heat resistance together can be obtained. Accordingly, the resin composition in the invention can be used preferably for the manufacture of molding products such as films, stretched films (particularly, biaxially stretched films), injection molding products, blow molding products, laminates, tapes, non-woven fabrics and yarns. The stretching and heat treatment conditions (temperature, temperature change, hysteresis, factors, time, etc.) are not particularly restricted so long as molding products having desired characteristics and properties can be obtained.

Usually, the stretching condition can be set properly considering the type, the thermal property, the molecular weight, etc. of the biodegradable polymer. The stretching temperature is usually selected within a temperate range of a glass transition temperature or higher and a melting point or lower of the degradable polymer and in a case, for example, where the ratio of the polylactic acid resin in the resin composition is relatively high, it is desirable that the temperature is usually about from 60 to 160° C., and, preferably, about from 60 to 100° C. Generally, the stretching factor is preferably from 2 to 20 times and, more preferably, from 4 to 15 times.

A temperature higher than the stretching temperature is generally selected for the heat treatment temperature and, for example, in a case where the ratio of the polylactic acid resin in the resin composition is relatively high, it is usually about from 80 to 160° C. and, preferably, from about 120 to 150° C. The heat treatment may be a continuous or batchwise operation. For example, in a case of heat treating a film obtained from the resin composition in the invention, a high performance film having a performance with a haze (cloudiness) of 10% or less, an elongation of 20% or more and not being deformed even after heating at 120° C. for 10 min can be prepared easily by properly setting the heat treatment condition. As described above, by applying heat treatment and/or stretching to the film obtained from the resin composition in the invention, remarkably high heat resistance can be provided in addition to high transparency and flexibility that could not be obtained by a heat treated polycaprolactone or polybutylene succinate film.

Usually, the shape of the resin composition before molding is preferably in a pellet, rod, powder or like other form. The resin composition in the invention can be made uniform by a mixer, and put to injection molding, blow molding, compression molding or the like under usual molding conditions.

A method of putting a resin composition in the invention to molding fabrication is to be described below.

### (1) Extrusion Molding

In extrusion molding, a resin composition in the invention can be molded into a film or a sheet by molding in a general T-die extrusion molder.

### (2) Injection Molding

In injection molding, pellets of a resin composition in the invention are melted to soften, and filled in a die kept at a room temperature or lower (−10 to 20° C.) to obtain a molding product at a molding cycle of 20 to 35 sec.

### (3) Blow Molding (Injection Blow Molding, Stretching Blow Molding, Direct Blow Molding)

For example, in the injection blow molding, pellets of a resin composition in invention are melted in a usual injection blow molder and filled in a die to obtain a preliminary molding product. After re-heating the obtained preliminary molding product in an oven (heating furnace), a blown bottle can be molded by charging the obtained preliminary molding product in a die kept at a room temperature or lower (−10 to 20° C.) and blown by the delivery of pressurized air.

### (4) Vacuum Forming

In vacuum forming/pressure forming, a film or a sheet molded by the same method as in the extrusion molding is formed into a preliminary molding product. Molding products can be obtained by heating and once softening the obtained preliminary molding product, and putting the same to vacuum forming or vacuum/pressure forming in a die kept at a room temperature or lower (−10 to 20° C.) by using a usual vacuum former.

### (5) Lamination Molding

In lamination molding, a lamination molding product can be obtained by (1) a method of laminating a film or a sheet obtained by the method of extrusion molding (1) with other substrate using an adhesive or heat, an extrusion lamination method of extruding a molten resin from a T die directly onto a substrate such as paper, metal or plastic by the same method as in the method of extrusion molding (1), a coextrusion method of melting resin compositions and the like in the invention respectively into separate extruders, joining them in a die head, and extruding the same simultaneously, or a method of coextrusion lamination by combining them.

Further, the film or the sheet manufactured from the resin composition in the invention can also be formed into a laminate of a multilayer structure, for example, by lamination or bonding with sheets of other materials such as paper or other polymer. Further, the resin composition in the invention has a flexibility and can be used suitably also as foams.

### EXAMPLES

The present invention is to be described specifically by way of examples but the invention is not restricted to such examples.

### Examples 1 to 4, Comparative Examples 1 to 9

### (Preparation of Polyolefin Resin-Coated Paper)

Bleached Kraft Pulp (LBKP) and Laubholz Bleached Sulfite Pulp (LBSP) as a 2:1 mixture were beaten to 320 ml according to Canadian Freeness to prepare a pulp slurry. 0.6 mass % of an alkyl ketene dimer as a sizing agent based on pulp, 1.2 mass % of polyacrylamide as a paper strength agent based on pulp, 1.2 mass % of cationized starch based on pulp, and 0.6 mass % of a polyamide polyamine epichlorohydrin resin based on pulp were added and diluted with water to form a 1% slurry. The slurry was made into paper to a basis weight of 165 g/m² by a Fourdrinier paper making machine, and dried and moisture controlled to form a substrate paper for polyolefin resin-coated paper. A polyethylene resin composition in which 10 mass % of anatase type titanium was uniformly dispersed to a resin of 100 mass % low density polyethylene was melted at 315° C. and extrusion coated at 200 m/min to the prepared substrate paper to 35 μm thickness, and extrusion coated by using a cooling roll applied finely roughened at the surface. A blend resin comprising 70 mass parts of high density polyethylene resin and 30 mass parts of low density polyethylene resin was melted at 315° C. in the same manner and extrusion coated to 35 μm thickness to the other surface, and extrusion coated by using a cooling roll finely roughened at the surface.

After applying a high frequency corona discharge treatment to the surface of the polyolefin resin coated paper, an undercoat layer of the following composition was coated and dried such that gelatin was 50 mg/m² to prepare a support. Parts mean mass parts of the solid content.

<Undercoat Layer>

| | |
|---|---|
| Lime treated gelatin | 100 parts |
| Sulfosuccinic acid-2-ethylhexyl ester salt | 2 parts |
| Chromium alum | 10 parts |

(Ink Jet Recording Material)

### (Ink Jet Recording Material A-1)

A coating liquid for an ink receiving layer of the following composition and a coating liquid for a colloidal silica layer were put to simultaneous double layer application by a slide bead coater to the surface of the obtained support provided with the undercoat layer. The concentration of the gas phase method silica in the coating liquid for the ink receiving layer was controlled to 9 mass %. The wet coating amount of the coating liquid for the ink receiving layer was 200 g/m² (solid coating amount of gas phase method silica: 18 g/m²). The concentration of the colloidal silica in the coating liquid for the colloidal silica layer was controlled to 8 mass %. The wet coating amount of the coating liquid for the colloidal silica layer was 12.5 g/m² (solid coating amount of the colloidal silica: 1 g/m²).

(Coating Liquid for Ink Receiving Layer)

| | | |
|---|---|---|
| Gas phase method silica | 100 | parts |
| (Average primary grain size: 7 nm, specific surface | | |
| area according to BET method: 300 m²/g) | | |
| Dimethylallyl ammonium chloride homopolymer | 4 | parts |
| (Sharol DC-902P, molecular weight: 9000, manufactured | | |
| by Dai-ichi Kogyo Seiyaku Co.) | | |
| Boric acid | 3 | parts |
| Polyvinyl alcohol | 22 | parts |
| (saponification degree: 88%, average polymerization | | |
| degree: 3500) | | |
| Basic polyaluminum hydroxide | 3 | parts |
| (trade name of product: PURECHEM WT, manufactured | | |
| by K. K. Riken Green) | | |
| 3,6-dithio-1,8-octanediol | 3 | parts |
| Surfactant | 0.3 | parts |
| (Betaine type: manufactured by Nippon Surfactant | | |
| Kogyo KK: Swanol AM) | | |

pH of the coating liquid was adjusted to 4.0.

<Coating Liquid for Colloidal Silica Layer>

| | | |
|---|---|---|
| Colloidal silica | 100 | parts |
| (anionic spherical colloidal silica: Snowtex ST-PL 40, | | |
| average primary grain size: 40 to 50 nm, manufactured | | |
| by Nissan Chemical Industries Co.) | | |
| Cationic polymer | 1 | part |
| (special modified polyamine; Polyfix 601, manufactured by | | |
| Showa High Polymer Co. Ltd.) | | |
| Polyvinyl alcohol | 4 | parts |
| (saponification degree: 88%, average polymerization | | |
| degree: 3500) | | |
| Surfactant | 0.3 | parts |
| (Betaine type: manufactured by Nippon Surfactant | | |
| Kogyo KK: Swanol AM) | | |

The coating liquid for the colloidal silica layer described above was prepared as below. At first, water was added to prepare an aqueous colloidal silica solution such that the concentration of the colloidal silica was 10 mass %. After increasing pH by gradually adding 0.5 mass % sodium hydroxide by 0.045 parts as the solid content while stirring the aqueous colloidal silica solution at a high speed by a high speed rotating disper, a cationic polymer (Polyfix 601) was added and further stirred at a high speed for 10 min. Then, the polyvinyl alcohol and the surfactant were added successively to prepare a coating liquid A. The pH of the coating liquid was 3.5.

The coating liquid for the ink receiving layer and the coating liquid for the colloidal silica layer were put to simultaneous double layer application to prepare an ink jet recording material A-1.

(Inkjet Recording Material A-2)

An ink jet recording material A-2 was prepared in the same manner except for not coating the coating liquid for the colloidal silica layer in the preparation of the ink jet recording material A-1.

(Ink Jet Recording Material A-3)

An ink jet recording material A-3 was prepared in the same manner except for not adding 3,6-dithio-1,8-octanediol to the coating liquid for the ink receiving layer in the preparation of the ink jet recording material A-2.

<Package for Ink Jet Recording Material>

Ink jet recording materials A-1 to A-3 prepared as described above were cut each into A4 size and overlapped to each other in the same direction each by 20 sheets, and packed and sealed with resin film bags (B-1 to B-7) shown in the following Table 1, to manufacture packages for ink jet recording materials of Examples 1 to 4 and Comparative Examples 1 to 9 shown in Table 1.

TABLE 1

| Resin | | Inkjet recording material | | |
|---|---|---|---|---|
| film bag | Film resin | A-1 | A-2 | A-3 |
| B-1 | Polylactic acid | Example 1 | Example 3 | Comp. |
| | Ecoloju SB Manufactured by Mitsubishi | | | Example 7 |
| | Plastics, Inc. | | | |
| B-2 | Polylactic acid/polyethylene carbonate | Example 2 | Example 4 | Comp. |
| | Lacea H-100, manufactured by | | | Example 8 |
| | Mitsui Chemical Co. | | | |
| B-3 | Polycaptolactone | Comp. | — | — |
| | Celgreen PH, manufactured by | Example 1 | | |
| | Daicel Chemical Industries, Ltd. | | | |
| B-4 | Polybutylene succinate/adipic acid | Comp. | — | — |
| | Bionolle, manufactured by | Example 2 | | |
| | Showa Highpolymer Co. Ltd. | | | |
| B-5 | Starch/PVA, | Comp. | — | — |
| | Mater-B, manufactured by | Example 3 | | |
| | Nippon Synthetic Chemical Industry Co., | | | |
| | Ltd. Novamont Co. | | | |
| B-6 | Polyhydroxybutylate | Comp. | — | — |
| | Biogreen, manufactured by | Example 4 | | |
| | Mitsubishi Chemical Co. | | | |
| B-7 | Polypropylene | Comp. | Comp. | Comp. |
| | Polyron PP, manufactured by | Example 5 | Example 6 | Example 9 |
| | Sekisui Film Co., Ltd. | | | |

In Table 1, the thickness for all of the film resins was 100 μm. Commercially available film resins were used being fabricated into a bag-like shape by a known method. Further, the polylactic acid/polyethylene carbonate resin film (B-2) was manufactured as described below.

70 mass parts of polylactic acid and 30 mass parts of polyethylene carbonate (measured glass transition temperature: 13° C., mass average molecular weight: 151,000) were charged in a glass reactor equipped with a stirrer and a distilling tube. The distilling tube was connected with a vacuum apparatus comprising a vacuum pump and a depressurization controller and structured such that distillation products can be removed by distillation.

The reactor was heated to 120° C., depressurized to 133 Pa and maintained for 4 hrs to remove the water content in the resin. Then, after returning to the normal pressure and elevating the temperature of the system to 210° C., the resin was mixed in a nitrogen atmosphere at 6650 Pa about for 1 hr and 30 min. Then, the inside of the system was returned to a normal pressure, and the resin composition was taken out. Then, the resin composition was dried sufficiently and, after putting a predetermined amount of the resin composition between each two sheets of brass plates, aluminum plates and releasing films, melting at 200° C. and compressing the same at 10 MPa for 1 min, the melts were compressed again and cooled at 10 MPa by a compression molder set to a temperature of 0° C. to mold into a 100 μm thickness. The obtained film was fabricated into a bag shape to manufacture the resin film bag B-2.

(Evaluation)

### (Evaluation for Yellowing]

The packages for the ink jet recording material of Examples 1 to 4 and Comparative Examples 1 to 9 were stored under the condition at 50° C. for 2 weeks. The ink jet recording material on the side in contact with the packaging material before storage and after storage was evaluated with naked eyes.

Yellowing was evaluated as A in a case where yellowing was not recognized at all, as B in a case where yellowing occurred somewhat but was scarcely conspicuous, as C where yellowing coloration occurred slightly, and as D where yellowing was significant. The result is shown in Table 2.

(Evaluation for Ozone Resistance)

Packages for the ink jet recording material of Examples 1 to 4 and Comparative Examples 1 to 9 obtained as described above were stored under the circumstance at an ozone concentration of 10 ppm and at a temperature of 23° C. for 1 week. Ink jet recording materials on the side in contact with the packaging material before storage and after storage were printed with images by using an ink jet printer “PM-G 800”, manufactured by Seiko Epson Co. and the change of images in both of them was evaluated with naked eyes.

Ozone resistance was evaluated as A in a case where image change was not recognized at all, as B in a case where image change occurred somewhat but was scarcely conspicuous, as C where image change occurred slightly, and as D where the image change was significant. The result is shown in Table 2.

(Evaluation for Bronzing)

Packages for the ink jet recording material of Examples 1 to 4 and Comparative Examples 1 to 9 were stored under the condition at 50° C. for 2 weeks. The ink jet recording material before storage and after storage were printed with solid cyan images at a maximum ink discharge amount by using an ink jet printer (PX-G 900) manufactured by Seiko Epson Co., and they were observed with naked eyes to evaluate the occurrence of bronzing.

Bronzing was evaluated as A in a case where occurrence of bronzing was scarcely observed, as B in a case where occurrence of bronzing could be confirmed somewhat, as C where bronzing could be confirmed but with no practical problem, and as D where bronzing could be confirmed distinctly and practical use was impossible. The result is shown in Table 2.

(Evaluation for Biodegradability)

Resin film bags used in Examples 1 to 4 and Comparative Examples 1 to 9 were buried in the ground of the usual natural environment, and the degree of decomposition was evaluated with naked eyes, after lapse of two months. The biodegradability was evaluated as B for a bag not decomposed substantially, as C for a bag decomposed slightly, and as D for a bag decomposed scarcely. The result is shown in Table 2.

TABLE 2

| | | Ozone | | |
|---|---|---|---|---|
| | Yellowing | resistance | Bronzing | Biodegradability |
| Example 1 | B | B | B-A | B |
| Example 2 | A | A | A | B |
| Example 3 | B | B | B | B |
| Example 4 | B-A | A | A | B |
| Comp. Example 1 | C | C | C | B |
| Comp. Example 2 | C | C | C | B |
| Comp. Example 3 | C | C | C | B |
| Comp. Example 4 | C | C | C | B |
| Comp. Example 5 | C | C | C-D | D |
| Comp. Example 6 | C | C | C-D | D |
| Comp. Example 7 | C | C | C-D | B |
| Comp. Example 8 | C | C | C | B |
| Comp. Example 9 | C | C | C-D | D |

It can be seen from Table 2 that the packaging materials for the ink jet recording material of Examples 1 to 4 were decomposed in the ground of the natural environment and imposed less burden on the environment.

In the ink jet recording material incorporated in the package for the ink jet recording material of Example 1 to 4, it can be seen that the occurrence of yellowing on the surface is suppressed, the ozone resistance of the printed portion when printed by a dye ink printer is favorable and the occurrence of bronzing is suppressed upon printing by a pigment ink printer.

The present invention can provide a package for the ink jet recording material capable of mitigating the burden on the environment when the packaging material of the package for the ink jet recording material is discarded after use in the packaging application, capable of suppressing the occurrence of yellowing in the ink receiving layer of the incorporated ink jet recording material, having favorable ozone resistance in the printed portion of the ink jet recording material when printed by the dye ink printer, and capable of suppressing the occurrence of bronzing when printed by the pigment ink printer.

That is, the present invention provides:

item (1): a package for an ink jet recording material wherein an ink jet recording material in which at least an ink receiving layer including fine inorganic particles and a thioetheric compound is disposed on a support is packaged by a packaging material comprising a polylactic acid resin;

item (2): a package for an ink jet recording material wherein an ink jet recording material in which at least an ink receiving layer including fine inorganic particles and a thioetheric compound is disposed on a support is packaged by a packaging material comprising a polylactic acid resin and a polyalkylene carbonate;

item (3): the package for an ink jet recording material according to the item (1), wherein the ink jet recording material has a layer including a colloidal silica and a cationic compound further disposed above the ink receiving layer;

item (4): the package for an ink jet recording material according to the item (2), wherein the ink jet recording material has a layer including a colloidal silica and a cationic compound further disposed above the ink receiving layer;

item (5): the package for an ink jet recording material according to any preceding item, wherein the fine inorganic particles are selected from the group consisting of a gas phase method silica, colloidal silica, alumina, and alumina hydrate;

item (6): the package for an ink jet recording material according to any preceding item, wherein the thioetheric compound is at least a compound represented by the following Formula (1):

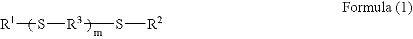

wherein in Formula (1), R¹ and R² independently represent a hydrogen atom, alkyl group, or aromatic group; R¹ and R² may be identical or different from each other or may be joined to form a ring; R³ represents an alkylene group which may be substituted or an oligo (alkyleneoxy)alkylene group which may be substituted; m represents an integer of from 0 to 10; and when m is 1 or more at least one sulfur atom bonded to R³ may be a sulfonyl group;

item (7): the package for an ink jet recording material according to item (2) or item (4), wherein the polyalkylene carbonate is a compound represented by the following Formula (5):

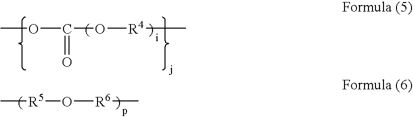

wherein in Formula (5), R⁴ is at least one group selected from an ethylene group, propylene group, or a group represented by the Formula (6); i represents an integer of from 1 to 15; j represents an integer of from 3 to 15,000; R⁵ and R⁶ independently represent an alkylene group having 2 to 6 carbon atoms; and p represents an integer of from 1 to 15;

item (8): the package for an ink jet recording material according to any preceding item, wherein the polylactic acid resin includes at least one of the following polylactic acid resins (1), (2), (3), or (4):

(1) a lactic acid homopolymer,

(2) a copolylactic acid resin having 50 mass % or more of a lactic acid and 50 mass % or less of a hydroxycarboxylic acid other than the lactic acid,

(3) a copolylactic acid resin having 50 mass % or more of a lactic acid and 50 mass % or less of an aliphatic polyhydric alcohol and an aliphatic polybasic acid, or

(4) a copolylactic acid resin having 50 mass % or more of lactic acid, and 50 mass % or less of a hydroxycarboxylic acid other than the lactic acid and an aliphatic polyhydric alcohol and an aliphatic polybasic acid.

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

What is claimed is:

1. A package for an ink jet recording material wherein an ink jet recording material in which at least an ink receiving layer including fine inorganic particles and a thioetheric compound is disposed on a support is packaged by a packaging material comprising a polylactic acid resin.

2. A package for an ink jet recording material wherein an ink jet recording material in which at least an ink receiving layer including fine inorganic particles and a thioetheric compound is disposed on a support is packaged by a packaging material comprising a polylactic acid resin and a polyalkylene carbonate.

3. The package for an ink jet recording material according to claim 1, wherein the ink jet recording material has a layer including a colloidal silica and a cationic compound further disposed above the ink receiving layer.

4. The package for an ink jet recording material according to claim 2, wherein the ink jet recording material has a layer including a colloidal silica and a cationic compound further disposed above the ink receiving layer.

5. The package for an ink jet recording material according to claim 1, wherein the fine inorganic particles are selected from the group consisting of a gas phase method silica, colloidal silica, alumina, and alumina hydrate.

6. The package for an ink jet recording material according to claim 2, wherein the fine inorganic particles are selected from the group consisting of a gas phase method silica, colloidal silica, alumina, and alumina hydrate.

7. The package for an ink jet recording material according to claim 3, wherein the fine inorganic particles are selected from the group consisting of a gas phase method silica, colloidal silica, alumina, and alumina hydrate.

8. The package for an ink jet recording material according to claim 4, wherein the fine inorganic particles are selected from the group consisting of a gas phase method silica, colloidal silica, alumina, and alumina hydrate.

9. The package for an ink jet recording material according to claim 1, wherein the thioetheric compound is at least a compound represented by the following Formula (1): 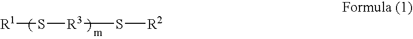
wherein in Formula (1), R¹ and R² independently represent a hydrogen atom, alkyl group, or aromatic group; R¹ and R² may be identical or different from each other or may be joined to form a ring; R³ represents an alkylene group which may be substituted or an oligo (alkyleneoxy)alkylene group which may be substituted; m represents an integer of from 0 to 10; and when m is 1 or more at least one sulfur atom bonded to R³ may be a sulfonyl group.

10. The package for an ink jet recording material according to claim 9, wherein the packaging material includes a polylactic acid resin and a polyalkylene carbonate.

11. The package for an ink jet recording material according to claim 9, wherein the ink jet recording material has a layer including a colloidal silica and a cationic compound further disposed above the ink receiving layer.

12. The package for an ink jet recording material according to claim 10, wherein the ink jet recording material has a layer including a colloidal silica and a cationic compound further disposed above the ink receiving layer.

13. The package for an ink jet recording material according to claim 1, wherein the polylactic acid resin includes at least one of the following polylactic acid resins (1), (2), (3), or (4):
(1) a lactic acid homopolymer,
(2) a copolylactic acid resin having 50 mass % or more of a lactic acid and 50 mass % or less of a hydroxycarboxylic acid other than the lactic acid,
(3) a copolylactic acid resin having 50 mass % or more of a lactic acid and 50 mass % or less of an aliphatic polyhydric alcohol and an aliphatic polybasic acid, or
(4) a copolylactic acid resin having 50 mass % or more of lactic acid, and 50 mass % or less of a hydroxycarboxylic acid other than the lactic acid and an aliphatic polyhydric alcohol and an aliphatic polybasic acid.

14. The package for an ink jet recording material according to claim 13, wherein the packaging material includes a polylactic acid resin and a polyalkylene carbonate.

15. The package for an ink jet recording material according to claim 13, wherein the ink jet recording material has a layer including a colloidal silica and a cationic compound further disposed above the ink receiving layer.

16. The package for an ink jet recording material according to claim 14, wherein the ink jet recording material has a layer including a colloidal silica and a cationic compound further disposed above the ink receiving layer.

17. The package for an ink jet recording material according to claim 2, wherein the polyalkylene carbonate is a compound represented by the following Formula (5): 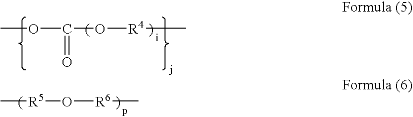
wherein in Formula (5), R⁴ is at least one group selected from an ethylene group, propylene group, or a group represented by the Formula (6); i represents an integer of from 1 to 15; j represents an integer of from 3 to 15,000; R⁵ and R⁶ independently represent an alkylene group having 2 to 6 carbon atoms; and p represents an integer of from 1 to 15.

18. The package for an ink jet recording material according to claim 17, wherein the ink jet recording material has a layer including a colloidal silica and a cationic compound further disposed above the ink receiving layer.

19. The package for an ink jet recording material according to claim 17, wherein the polylactic acid resin includes at least one of the following polylactic acid resins (1), (2), (3), or (4):
(1) a lactic acid homopolymer,
(2) a copolylactic acid resin having of 50 mass % or more of a lactic acid and 50 mass % or less of a hydroxycarboxylic acid other than the lactic acid,
(3) a copolylactic acid resin having 50 mass % or more of a lactic acid and 50 mass % or less of an aliphatic polyhydric alcohol and an aliphatic polybasic acid, or
(4) a copolylactic acid resin having 50 mass % or more of lactic acid, and 50 mass % or less of a hydroxycarboxylic acid other than the lactic acid and an aliphatic polyhydric alcohol and an aliphatic polybasic acid.

20. The package for an ink jet recording material according to claim 19, wherein the ink jet recording material has a layer including a colloidal silica and a cationic compound further disposed above the ink receiving layer.
